(19) United States
(12) Patent Application Publication
(10) Pub. No.: US 2010/0175191 A1
(43) Pub. Date: Jul. 15, 2010

(54) Adjustably Positionable Bed

(76) Inventor: Werner Muehle, Weilrod (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/686,671

(22) Filed: Jan. 13, 2010

(30) Foreign Application Priority Data
Jan. 13, 2009 (DE) DE202009000351.5

(51) Int. Cl. A61G 7/008

(52) U.S. Cl. 5/607

(57) ABSTRACT

An adjustably positionable bed having a support frame (1) and a mattress frame (4) arranged thereon is characterized in that cylindrical axle elements (5), which engage in upwardly open, forked bearings (9) mounted on the support frame (1), are attached to the mattress frame (4) parallel to the longitudinal sides of the mattress frame, and at least one lifting device (3) mounted on the support frame (1) is provided for selectively lifting one longitudinal side of the mattress frame (4).

### BACKGROUND OF THE INVENTION

The present invention relates to an adjustably positionable bed comprising a support frame and a mattress frame arranged thereon.

Conventional beds consist of a mattress frame upon which a mattress is laid. Support planks or cross members are provided, which are placed on the longitudinal frame parts crosswise to the longitudinal direction of the mattress frame and are preferably resilient. In one comfortable embodiment, the support planks are mounted on separately adjustable back and leg pieces that permit a seated posture and an angled thigh and lower-leg support as desired. Such a mattress frame can be placed on a support frame in a bed frame.

For long-term patients or physically handicapped patients, it is necessary to note that prolonged lying will cause diminished blood circulation and moist heat at locations on the body that are in direct contact with the bed. The lying person then not only needs to change his or her lying or seating position, but must also rotate, e.g., to relieve the buttocks in the seating posture. Frequently, however, patients are not capable of doing this themselves because of their condition or handicap.

Rotating a patient or laying a patient on his/her side for washing, changing clothes/linens or massaging is difficult for caregivers, especially when the work posture requires the caregiver to bend forwards over the lying surface. Lifting a seated patient out of the bed is complicated and difficult when the patient is unable to bend relative to the caregiver.

A hospital bed in which the lying surface of the mattress frame can be modified from a level flat lying surface in a variety of ways is known from German utility model no. DE 296 10 699 U1. In addition to a wave-like lying surface from alternately raised support planks, it is also possible to elevate a back part and a leg part. Support planks can be raised out of the level lying surface, which make it possible to change the patient's side position. The large number of adjustment possibilities and the drive means that are provided for these adjustments and which can be controlled independently of one another make the overall structure costly, complicated and expensive.

### SUMMARY OF THE INVENTION

The object of the invention was to provide an adjustably positionable bed that is constructed of standard mattress frames and support frames and requires only a simple supplementary assembly.

This and other objects are achieved in accordance with the invention by providing an adjustably positionable bed of the aforementioned type in which cylindrical axle elements, which engage upwardly open, forked bearings mounted on the support frame, are attached to the mattress frame parallel to the longitudinal sides of the mattress frame and in which at least one lifting device supported on the support frame is provided for selectively lifting one longitudinal side of the mattress frame.

The depth of the forked bearing should be no more than twice the diameter of the cylindrical axle element in order to keep the mounting height small. The forked bearings can each have a foot member, which points toward the outside of the support frame and at least partially surrounds the cylindrical axle element and which prevents the cylindrical axle elements from being pushed out of the forked bearing when the opposite longitudinal side is lifted. The cylindrical axle element can be constructed as a pin secured on one side, but it can also be secured to support members on both ends. The cylindrical axle element is preferably provided with a plastic roller or cover.

To properly center the mattress frame in the support frame, the spacing between the cylindrical axle elements adjacent the respective opposite longitudinal sides and the spacing between the openings of the respective forked bearings associated with the axle elements should be equal. To facilitate insertion of the axle elements into the forked bearings, it is advantageous for the insertion areas of the forked bearings to have conical or tapered openings.

In accordance with the invention, conventional mattress frames, whether having a continuous lying surface or with adjustable subelements, can be used by attaching cylindrical axle elements to the mattress frame and corresponding forked bearings to the support frame. With the aid of at least one conventional lifting device supported on the support frame, it is possible to rotate the entire mattress frame laterally around the axle elements resting in the forked bearings.

### BRIEF DESCRIPTION OF THE DRAWINGS

The invention will be described in further detail hereinafter with reference to an illustrative preferred embodiment shown in the accompanying drawing figures, in which:

FIG. 1 is a longitudinal side view of an adjustably positionable bed according to the present invention;

FIG. 2 is a transverse side view of the bed of FIG. 1;

FIG. 3 is transverse side view of the bed with the left side member raised, and

FIG. 4 is a transverse side view of the bed with the right side member raised.

### DETAILED DESCRIPTION OF PREFERRED EMBODIMENTS

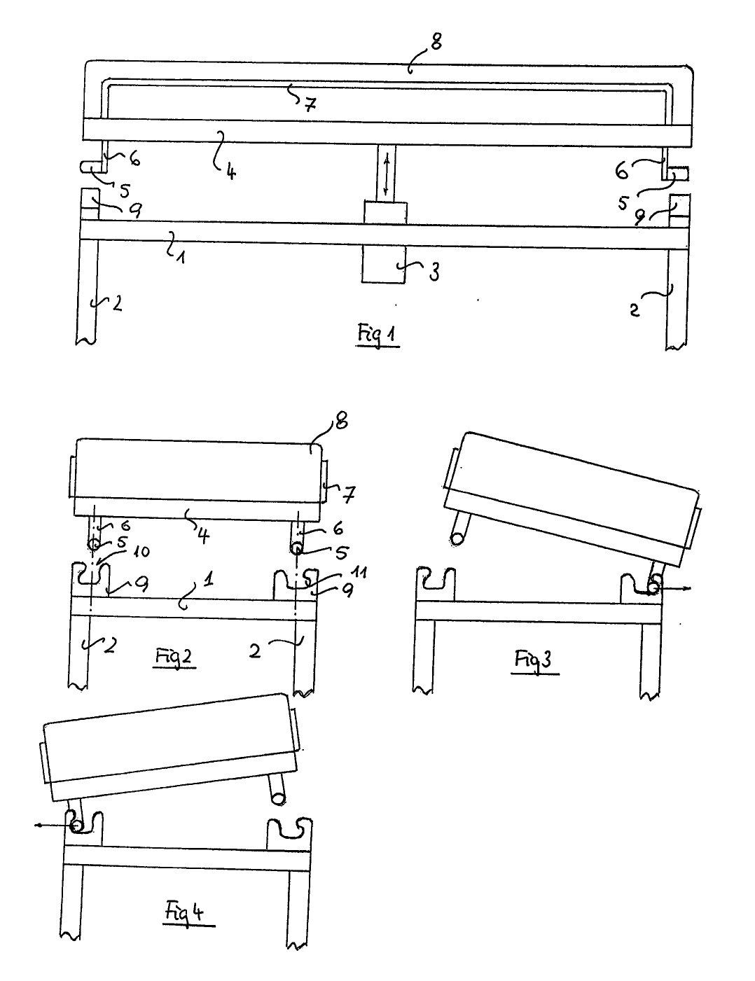

The longitudinal side view illustrated in FIG. 1 depicts a support frame 1, which is carried by foot pieces 2, illustrated only schematically. The foot pieces can form a height-adjustable bed frame and be supported by rollers or wheels that can be locked into position. A lifting device 3, shown here as a hydraulic or pneumatic piston and cylinder arrangement which lifts a mattress frame 4, is mounted on the support frame 1. Instead of the piston and cylinder device, it is also possible to utilize a suitable lever arrangement as the lifting device. Since the mattress frame 4 describes a circular arc during the lifting, the lever arrangement must be attached to the mattress frame 5 with a sufficient play of movement to allow it to compensate for the circular movement of the mattress frame when raised.

Cylindrical axle elements 5 are attached to the mattress frame 4 aligned in parallel with the longitudinal direction of the mattress frame. Instead of the illustrated arrangement comprising axle elements 5 constructed as pins each attached at one end to a support 6, it is also possible to affix both ends of the pins to support members on the mattress frame. It is likewise possible to secure axial ends of the axle elements 5 to the mattress frame 4 or to receive them in a cutout in the mattress frame 4.

A rail 7, which is intended to prevent a mattress 8 from slipping when the lying surface is tilted laterally, is secured to the longitudinal sides of the mattress frame 4 in a conventional manner. The mattress 8 is preferably configured with a soft central lying surface and lateral reinforcements, which support a patient during the lateral tilting of the lying surface and stabilize him or her.

The axle elements 5 are preferably provided with plastic rollers or covers, which engage in upwardly open forked bearings 9 fastened to the support frame 1 when the mattress frame 4 is lowered. The positions of the bearings 9 correspond to the arrangement of axle elements 5 on the mattress frame 4 so that each axle element 5 is received in a forked bearing 9.

FIG. 2 is a first transverse side view showing the mattress frame 4 with the cylindrical axle elements 5 fastened thereto and the support frame 1 with the forked bearings 9 mounted on the support frame. The spacing between the insertion openings 10 of the forked bearings 9 is equal to the spacing between their associated axle elements 5, so that the mattress frame 4 can be inserted into the forked bearings 9 without further adjustment. To further facilitate the insertion, the insertion openings 10 may be conical or tapered, if desired.

The seat region of the forked bearings 9 is provided with foot members 11, which point away from the support frame. The foot members 11 are so formed with a nose or projection at the upper ends thereof that they extend partially around the cylindrical axle elements 5. To provide the overlapping portion of bearing 9 with sufficient material thickness, the insertion depth of bearing 9 corresponds to approximately twice the diameter of axle element 5.

When the mattress frame 4 is placed upon the support frame 1, the axle elements 5 essentially rest against the vertical internal sides of the forked bearings 9, so that they can slide out of the bearing 9 when the mattress frame 4 is lifted on one side.

When the mattress frame 4 is lifted on one side, the axle element 5 remaining in the bearing 9 is pushed against the foot member 11 under the projecting nose, which ensures that this axle element 5 will securely remain in the bearing 9.

FIGS. 3 and 4 depict the displacement of the axle elements 5 when the mattress frame 4 is lifted on the left and on the right sides, respectively. When the mattress frame 4 is lowered back into the horizontal lying position, the incoming axle element 5 slides along the tapered insertion opening 10 of the forked bearing 9 which it is re-entering, thereby pulling the other axle element 5 out from under the projecting nose of the foot member 11.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. An adjustably positionable bed comprising a support frame and a mattress frame arranged on said support frame, wherein cylindrical axle elements are attached to the mattress frame parallel to longitudinal sides of the mattress frame, said axle elements being received in upwardly open, forked bearings mounted on the support frame, and at least one lifting device is provided on the support frame for selectively lifting one longitudinal side of the mattress frame.

2. An adjustably positionable bed according to claim 1, wherein the forked bearings have a depth not more than twice the diameter of the cylindrical axle elements.

3. An adjustably positionable bed according to claim 1, wherein the forked bearings each comprise an foot member at the outer periphery of the support frame and pointing away from the support frame, said foot member extending at least partially around a cylindrical axle element received in the forked bearing.

4. An adjustably positionable bed according to claim 1, wherein the cylindrical axle element is constructed as a pin attached at one end to a support on the mattress frame.

5. An adjustably positionable bed according to claim 1, wherein the cylindrical axle element is attached at both ends to supports on the mattress frame.

6. An adjustably positionable bed according to claim 1, wherein the cylindrical axle element is provided with a plastic roller.

7. An adjustably positionable bed according to claim 1, wherein opposed cylindrical axle elements adjacent opposite longitudinal sides of the mattress frame are spaced apart a distance equal to the spacing between insertion openings of forked bearings in which the respective cylindrical axle elements are received.

8. An adjustably positionable bed according to claim 1, wherein forked bearings have tapered insertion openings for facilitating entry of the cylindrical axle elements into respective forked bearings.
